(19) United States
(12) Patent Application Publication
(10) Pub. No.: US 2024/0410863 A1
(43) Pub. Date: Dec. 12, 2024

(54) SAMPLE INJECTOR WITH FLOATING NEEDLE SEAT FOR AN ANALYTICAL DEVICE

(71) Applicant: Agilent Technologies, Inc., Santa Clara, CA (US)

(72) Inventors: Blasius Nocon, Rheinstetten (DE); Christoph Geiger, Birkenfeld (DE)

(21) Appl. No.: 18/735,742

(22) Filed: Jun. 6, 2024

(30) Foreign Application Priority Data
Jun. 8, 2023 (GB) 2308528.5

(51) Int. Cl. G01N 30/24

(52) U.S. Cl. CPC G01N 30/24

(57) ABSTRACT

A sample injector for an analytical device includes a needle seat configured to receive a needle for injecting a sample into an injector path. The needle seat is mounted in a floating manner so that the orientation of the needle seat is aligned automatically with respect to the orientation of the approaching needle. The sample injector may be provided in an analytical device such as a chromatographic device.

### CROSS-REFERENCE TO RELATED APPLICATIONS

The present application claims the benefit of British patent application No. GB 2308528.5, filed on Jun. 8, 2023, which is incorporated herein by reference in its entirety.

### TECHNICAL FIELD

The present disclosure relates to a sample injector for an analytical device, in particular a sample injector that includes a needle seat mounted in a floating manner. The sample injector may be operated with an analytical device, in particular a chromatography device such as a high-performance liquid chromatography (HPLC) device.

### BACKGROUND

Analytical devices are provided for analyzing a sample, such as for carrying out a chromatographic separation of the sample.

For example, for liquid separation in a chromatography system, a mobile phase comprising a sample fluid (e.g. a chemical or biological mixture) with compounds to be separated is driven through a stationary phase (such as a chromatographic column packing), thus separating different compounds of the sample fluid which may then be identified.

The mobile phase, typically comprised of one or more solvents, is pumped under high pressure typically through a chromatographic column containing packing medium (also referred to as packing material or stationary phase). As the sample is carried through the column by the liquid flow, the different compounds, each one having a different affinity to the packing medium, move through the column at different speeds.

Those compounds having greater affinity for the stationary phase move more slowly through the column than those having less affinity, and this speed differential results in the compounds being separated from one another as they pass through the column. The stationary phase is subject to a mechanical force generated in particular by a hydraulic pump that pumps the mobile phase usually from an upstream connection of the column to a downstream connection of the column. As a result of flow, depending on the physical properties of the stationary phase and the mobile phase, a relatively high-pressure drop is generated across the column.

The mobile phase with the separated compounds exits the column and passes through a detector, which registers and/or identifies the molecules, for example by spectrophotometric absorbance measurements. A two-dimensional plot of the detector measurements against elution time or volume, known as a chromatogram, may be made, and from the chromatogram the compounds may be identified. For each compound, the chromatogram displays a separate curve feature also designated as a “peak”.

In preparative chromatography systems, a liquid as the mobile phase is provided usually at a controlled flow rate (e.g., in the range of 1 mL/min to thousands of mL/min, e.g. in analytical scale preparative LC in the range of 1-5 mL/min and preparative scale in the range of 4-200 mL/min) and at pressure in the range of tens to hundreds bar, e.g. 20-600 bar.

In high performance liquid chromatography (HPLC), a liquid as the mobile phase has to be provided usually at a very controlled flow rate (e.g. in the range of microliters to milliliters per minute) and at high-pressure (typically 20-100 MPa, 200-1000 bar, and beyond up to currently 200 MPa, 2000 bar) at which compressibility of the liquid becomes noticeable.

In analytical devices, specifically in liquid chromatography (in particular HPLC), it may be important to inject a sample into the analytical device in a reliable manner. Generally, an injection/sample needle is used that uptakes (aspirates) a fluidic sample from a sample container, transports the sample to a sample injector of the analytical device, and injects the fluidic sample into a needle seat of the sample injector, to thereby inject the sample into an injection path of the analytical device.

Conventionally, the analytical seat or needle seat is stationary, i.e. fixed at the sample injection region, generally in an autosampler space. The needle is generally fixed at a moving arm that automatically moves within the sampler space. The moving arm places the needle above the needle seat and then moves the needle downwards, so that the needle approaches an opening (for sample injection) of the sample injector. However, the orientation of the needle (in particular in the vertical direction downwards (in the direction of gravity)) and the orientation of the needle seat (in the vertical direction upwards) can be misaligned (see e.g. FIGS. 4A and 5A). This may have the disadvantage that the associated robotics (e.g. moving arm) require a high absolute positional accuracy and repeatability. The temperature influences of the materials used may also have to be taken into account. These circumstances may render existing systems complex and costly.

GB 2486678 A describes a seat for a fluid separation device, wherein an injection needle is selectively insertable into the seat for conducting a fluid between the needle and the seat, and wherein the injection needle is selectively movable out of the seat. The seat has a mechanism configured for permitting an adjustment of the seat relative to the needle upon inserting the needle into the seat for thereby at least partially balancing a potential misalignment between the needle and the seat.

### SUMMARY

There may be a need to inject a sample into an analytical device in an efficient and reliable manner.

According to an aspect, there is described a sample injector for an analytical device (e.g. a chromatographic device), comprising: a needle seat, configured to receive an approaching needle (e.g. coupled to a sample transport device) for a sample injection into an injector path (of the analytical device). The needle seat is hereby mounted (in the sample injector) in a floating manner, so that the orientation of the needle seat is aligned automatically (active or passive) with respect to the orientation of the approaching needle (thereby automatically compensating for a misalignment).

According to a further aspect, a sample injector arrangement is described, comprising: a sample injector as described above, and a sample transport device that is coupled to the needle (and configured to transport the needle).

According to a further aspect, an analytical device, in particular a sample separation device (in particular a (fluidic) chromatography device, more in particular a high-performance liquid chromatography (HPLC) device) is described, wherein the analytical device comprises a sample injector and/or a sample injector arrangement as described above.

According to a further aspect, there is described a method, comprising:
i) mounting a needle seat of an analytical device in a floating manner (e.g. at least partially on a floating region);
ii) approaching a needle (e.g. coupled to a sample transport device) (downwards) towards the needle seat; and
iii) automatically aligning the orientation of the floating needle seat with respect to the orientation of the approaching needle.

According to a further aspect, there is described a use of (or a method of using) a needle seat for an analytical device in a floating manner (mounting in a floating manner), so that an axis misalignment between the orientation of the needle seat and an orientation of an approaching needle is automatically compensated for.

According to a further aspect, there is described a sample injector for an analytical device, comprising: i) a needle; ii) a guidance device being coupled with the needle; and iii) a needle seat configured to receive the needle for a sample injection into an injector path. The needle seat is mounted in a floating manner, and the guidance device is configured to align an orientation of the needle seat with respect to an orientation of the needle (in order to align the orientation of the needle seat with respect to the orientation of the needle) (in other words: wherein the needle seat is mounted in a floating manner, so that the orientation of the needle seat is aligned automatically with respect to the orientation of the approaching needle, in that the orientation of the needle seat follows the orientation of the needle, as provided by the guidance device, before the needle seat receives the needle).

According to a further aspect, there is described a method, comprising: i) mounting a needle seat of an analytical device in a floating manner; ii) approaching a needle being coupled to a guidance device to the needle seat; and iii) aligning with (using) the guidance device an orientation of the needle seat with respect to an orientation of the needle (in order to align the orientation of the needle seat with respect to the orientation of the needle).

In the context of the present document, the term “sample injector” may in particular refer to a device configured as an interface between a (fluidic) sample and an analytic domain. In an example, the sample injector comprises an opening for receiving an approaching sample needle that is loaded with the sample. The needle may fluidically couple with the sample injector and introduce the sample through the sample injector and into the analytic domain, in particular through an injection path. The analytic domain may be part of an analytical device, e.g. a separation column of a chromatography device. The sample injector may be part of the analytical device or a stand-alone device coupled to the analytical device.

In the context of the present document, the term “needle seat” may in particular refer to a device configured to receive an approaching sample needle that is loaded with a sample. The needle seat may be a part of the above-described sample injector and may comprise the opening for the needle. Thus, the needle seat may be specifically designed to receive the needle (e.g. by an elongated part), so that the sample loaded by the needle may be directly introduced into the needle seat, in particular into an injection path coupled with the needle seat.

The term “floating” may in particular refer to a specific kind of mounting, wherein the floating device (in particular a needle seat) is mounted (e.g. on a needle seat mounting device) in a movable manner. For example, the term “floating” may refer to the circumstance that the needle seat is movable (comprises a degree of freedom) along at least one axis/direction. In an example, the mounted device may be movable within a tolerance region, e.g. in a planar manner (along the X-Y plane) and/or in a vertical manner (along Z direction). The term “floating” may hereby describe the opposite of a non-floating manner, e.g. a fixed mounting or a stationary mounting. In an example, the floating is implemented by a floating region between a needle seat and a needle seat mounting device, wherein the floating region comprises a non-fixing material, e.g. a lubricant, or a non-fixing bearing, e.g. a ball bearing. Additionally or alternatively, the mounting device may comprise a tolerance region/space that allows a specific movement of the mounted needle seat.

In the context of the present document, the term “aligned automatically” may refer to an active (by the needle seat itself) or passive (the orientation of the needle seat follows the orientation of the approaching needle) alignment. In a preferred example, the automatic alignment is provided in that the orientation of the needle seat follows the orientation of the needle before (e.g. the needle is coupled to a guidance device (e.g. a pusher device or an alignment element), and the guidance device is aligned and thereby aligns the needle) and/or during (e.g. provided by the needle itself) the process of the needle seat receiving the needle.

In the context of the present document, the term “analytical device” may in particular refer to a device suitable to perform an analysis of a sample. In an example, the analytical device is applied to analyze (characterize) a sample-by-sample separation (such as chromatography), which may be termed analysis domain in the following. In the context of the present document, the term “chromatography device” may in particular refer to an instrument suitable to perform a chromatographic analysis, preferably for analyzing a sample, such as for carrying out a chromatographic separation of the sample. Examples of a chromatography device may include a high-performance liquid chromatography (HPLC) instrument or a gas chromatography (GC) instrument.

According to an exemplary embodiment, the disclosure may be based on the idea that a sample can be injected into an analytical device in an efficient and reliable manner, when the sample is transported in a sample needle that approaches (in the vertical direction) a needle seat of a sample injector (coupled to the analytic domain of the analytical device), whereby the needle seat is mounted in a floatable (movable, not fixed) manner. Thereby, a misalignment of the orientation of the approaching needle and the needle seat may be compensated for automatically, since the floatable needle seat is automatically aligned by the approaching needle to a position, wherein both orientations are aligned with each other.

Conventionally, a misalignment between sample needle and needle seat is accepted or partially compensated for by moving (by plastic or elastic bending of the needle) the needle or the needle transport device to which the needle is connected. However, these approaches may come along with a high error rate, mainly based on missing accuracy of the transport device and/or temperature changes.

However, it has been surprisingly found that a highly efficient and reliable alignment may be achieved automatically (i.e. merely by mechanically approaching the needle seat with the needle), when it is the needle seat that is mounted in a floating manner instead of the needle and/or the transport device. The described approach may be implemented into existing analytical devices in a straightforward manner, thereby eventually improving the overall analytical device performance.

In particular, the needle may be supported by a guidance device (e.g. a pusher device or an alignment element) to perform the alignment of the floating needle seat. For example, the guidance element may be in physical contact with the needle seat and thereby align the needle seat to an orientation of the needle. In this manner, the delicate needle may be efficiently protected and aligned at the same time.

### EXEMPLARY EMBODIMENTS

In the following, further embodiments of the disclosure are described. These apply to the device(s) as well as to the method and the use.

In one embodiment, the sample injector further comprises: a needle seat mounting device, configured to mount the needle seat in the floating manner, in particular wherein the needle seat mounting device is a stationary device (a fixed device, a non-floating manner mounted device). This may provide the advantage that the needle seat can be mounted in a robust and stable, but floating, manner. In a basic example, the needle seat mounting device may be realized by a support plate (see e.g. FIGS. 2 and 3). In a more complex example, the needle seat mounting device may comprise a tower structure that at least partially surrounds the needle seat (see e.g. FIG. 4). Preferably, the needle seat mounting device comprises an opening and/or a channel to connect the needle seat fluidically to an injection path of the analytical device.

In an embodiment, the needle seat mounting device comprises a tolerance region, so that a movement, in particular a planar movement, of the needle seat is allowed/enabled. This may provide the advantage that the mounting in a floatable manner of the needle seat can be enabled in a basic, yet efficient, manner. By providing a region of specific tolerance (a free space region), for example between an outer sidewall of the needle seat and a sidewall of a needle seat mounting device tower structure, an alignment of the needle seat may be allowed. Besides a tolerance region in the horizontal direction, there may be also a tolerance region in the vertical direction (e.g. like a slide), to enable a movement of the needle seat in the vertical direction.

In an embodiment, the sample injector further comprises a floating region, in particular a floating surface, onto which the needle seat is mounted. Thereby, the mounting in a floating manner may be realized in an easy and efficient manner that requires little space.

In an embodiment, the floating region is arranged between, in particular directly between, the needle seat mounting device and the needle seat. This embodiment may further improve the above-described mounting technique, since the direct contact between needle seat and mounting device would not be stationary (fixed). For example, the floating region may be realized as a circumferential (e.g. circular) region between needle seat and mounting device (see e.g. FIG. 4A). In another example, the floating region may cover the entire contact region between needle seat and mounting device (see e.g. FIGS. 2 and 3).

In an embodiment, the floating region comprises at least one of the following: a ball bearing, a roller bearing, a fluid bearing (e.g. an oil bearing, an air bearing etc.), a gel bearing, a friction-reducing material, a sliding surface, a lubricant. This may provide the advantage that established technical means may be directly implemented. Depending on the desired application, specific floating region means/materials can be preferable. For example, a friction-reducing material may require less space, while a ball bearing may be more stable and/or more reliably adjustable.

In an embodiment, the sample injector is configured so that: the needle seat is floating (movable) in a planar direction (in particular in the x-y plane) and/or the needle seat is at least partially floating (movable) in a vertical direction, in particular along the Z-axis. In an embodiment, the needle seat may be movable at least in a direction/axis, where the approaching needle is fixed (not floating). Thereby, an accurate alignment may be enabled.

In an embodiment, the sample injector further comprises: the injector path, (fluidically) coupled with the needle seat, and configured to receive the injected sample from the needle, in particular wherein the injector path is mounted in a stationary (non-floating) manner. The presence of a fixed injector path may render a floating/adjustable needle seat especially advantageous. Accordingly, the described sample injector may be established in existing analytical devices in a straightforward manner.

In an embodiment, the needle seat comprises a tapering (in particular a cone-shaped like) part that tapers towards the approaching needle. In particular, the tapering part is configured to be automatically aligned by an approaching opening of a guidance device (here pusher device), being coupled with the needle. Thereby, the automatic adjustment may be realized in an accurate and reliable manner using existing structures. An example for such an adjustment is illustrated in FIGS. 4B and 4C. A sample transport device may comprise an opening through which the needle is guided for sample uptake/injection. In particular, said opening is formed at the pusher/gripper device of the sample transport device. By approaching the top (tapering structure) of the needle seat, the tapering structure may be automatically aligned by the shape of the opening (e.g. moving sidewards since the needle seat is arranged in a floating manner). Hereby, the tapering structure may fit into the opening, eventually even by a form-fit connection.

In an embodiment, the needle seat comprises a tapering, in particular a cone-like, part. In an embodiment, the guidance device interacts with the tapering part/structure in order to align the orientation of the needle seat with respect to the orientation of the needle. In an embodiment, the tapering part is configured to be (automatically) aligned by an approaching opening of a guidance device (being coupled with the needle). In an embodiment, the tapering direction is towards the approaching needle. In another embodiment, the tapering direction is opposite to the approaching needle (the tapering could also have the inverse orientation/shape, i.e. a tapering in the direction of the approaching needle).

In an embodiment, the guidance device (e.g. a pusher device) and the needle are fixedly coupled with each other with respect to their axis of movement (in particular the vertical direction, up and down). In other words, an axis of movement of the guidance device is fixedly coupled with an axis of movement of the needle. The orientation of the fixedly coupled guidance device and needle may be preferably in parallel or coaxial. This may provide the advantage that guidance device and needle move together, and the guidance device can directly align the needle to the needle seat.

In an embodiment, the guidance device comprises an alignment element (e.g. an alignment pin). Preferably, the alignment element is coupled coaxially with the needle (preferably fixed in the moving direction) to provide the orientation/alignment of the needle to the needle seat (see e.g. FIGS. 6A to 6C). In an example, the axis of movement of the needle as well as the axis of movement of the alignment element are in parallel/coaxial with each other. The orientation provided by the alignment element may thus automatically lead to the desired orientation of the needle.

In an embodiment, the needle is arranged in a non-floating manner or in a floating manner. Depending on the desired application, a stationary or a non-stationary needle may be preferable. In the latter case, the needle and the needle seat may automatically align with each other.

In an example, the sample injector arrangement further comprises: a moving arm, coupled to the needle, and configured to move the needle from a sample uptake position towards the needle seat. Accordingly, the described floating needle seat may be advantageously implemented directly into existing industry applications.

In an embodiment, the sample injector arrangement is configured so that the orientation of the needle seat is aligned automatically with respect to the orientation of the needle at least along an axis in which the needle and/or the moving arm is stationary. Thus, each stationary axis/direction may be compensated for by a corresponding floating axis/direction.

In an embodiment, the sample injector arrangement further comprises: a needle guidance device (e.g. a pusher/gripper device), in particular coupled to the moving arm, coupled to the needle, and configured to guide the needle towards the needle seat. Thereby, accuracy of the needle orientation may be improved. Further, the needle may be protected.

In an embodiment, the guidance device comprises an opening, configured to automatically align the orientation of the needle seat, in particular the tapering structure of the needle seat (see FIGS. 4B and 4C for an illustrative example).

In an embodiment, the method further comprises: injecting the sample from the needle into the needle seat, and in particular into an injector path of the analytical device. Thus, the method may be implemented directly in existing workflows.

According to one embodiment, the (sample) needle can be inserted fluid-tightly (preferably in high-pressure, robust manner) (e.g. by means of a moving arm) into the needle in order to guide fluidic sample through the sample needle and through the needle seat. When the sample needle is inserted into the needle seat, previously up-taken fluidic sample can be transferred to a separation path of the analytical device for separation.

In an embodiment, due to the freely movable (floating) seat in the X-Y plane, the special external geometries of the needle seat and a guidance device (vial pusher) ahead of the needle can move the needle seat towards the center of the needle orientation during a vertical (Z) movement of a transport (robot) arm. Thus, a concentricity error between needle and needle seat can be reduced to a minimum and thus also the drawbacks of conventional methods. In a specific embodiment, the same effect may also be achieved by appropriate geometries of the needle guided in the inner needle seat and the needle itself, or by a combination of both.

In an embodiment, another way to compensate for the axial error of the needle and the needle seat may be that both the needle and the needle seat can be suitably cardanically suspended, or the needle seat can be arranged floating on a sphere with a sufficiently large radius.

In one embodiment, the sample separation device further comprises: a mixing point, where a sample is injected into the solvent, wherein the fluid compartment (the analytical device) is arranged upstream or downstream of the mixing point.

In one embodiment, the sample separation device further comprises: a solvent mixing point, where at least two solvent portions may be mixed, wherein the fluid compartment (the analytical device) is arranged upstream or downstream of the solvent mixing point.

In one embodiment, the sample separation device further comprises: a solvent drive, configured to drive the solvent as a mobile phase, wherein the fluid compartment (the analytical device) is arranged upstream or downstream of the solvent drive.

It becomes evident from the embodiments described directly above, that there is a high design flexibility regarding where the fluid compartment can be located in the analytical device/sample separation device. Depending on the present circumstances and the applied measurement method, different locations may be specifically favorable.

In one embodiment, the chromatography device is a fluidic chromatography device, in particular a high-performance liquid chromatography, HPLC, device.

In one embodiment, the chromatography device comprises a mobile phase (solvent) drive and a separating device, wherein the mobile phase drive is configured for driving a mobile phase through the separating device, and the separating device is configured for chromatographically separating compounds of a sample fluid in the mobile phase.

In one embodiment, the analytical device and/or the sample separation device comprises a liquid chromatography system, wherein the sample fluid is a sample liquid, the mobile phase is comprised of one or more liquid solvents, and the separating device is a chromatographic column configured for separating compounds of the sample dissolved in the mobile phase.

Embodiments of the present disclosure might be embodied based on most conventionally available HPLC systems, such as the Agilent 1220, 1260 and 1290 Infinity LC Series (provided by the applicant Agilent Technologies).

The separating device preferably comprises a chromatographic column providing the stationary phase. The column might be a glass, metal, ceramic or a composite material tube (e.g. with a diameter from 50 μm to 5 mm and a length of 1 cm to 1 m) or a microfluidic column (as disclosed e.g. in EP 1577012 A1 or the Agilent 1200 Series HPLC-Chip/MS System provided by the applicant Agilent Technologies). The individual components are retained by the stationary phase differently and separate from each other while they are propagating at different speeds through the column with the eluent. At the end of the column, they elute at least partly separated from each other. During the entire chromatography process the eluent might be also collected in a series of fractions. The stationary phase or adsorbent in column chromatography usually is a solid material. The most common stationary phase for column chromatography is silica gel, followed by alumina.

The mobile phase (or eluent) can be either a pure solvent or a mixture of different solvents. It can also contain additives, i.e. be a solution of the said additives in a solvent or a mixture of solvents. It can be chosen e.g. to adjust the retention of the compounds of interest and/or the amount of mobile phase to run the chromatography. The mobile phase can also be chosen so that the different compounds can be separated effectively. The mobile phase might comprise an organic solvent like e.g. methanol or acetonitrile, often diluted with water. For gradient operation water and organic solvent is delivered in separate containers, from which the gradient pump delivers a programmed blend to the system. Other commonly used solvents may be isopropanol, tetrahydrofuran (THF), hexane, ethanol and/or any combination thereof or any combination of these with aforementioned solvents.

The sample fluid might comprise any type of process liquid, natural sample like juice, body fluids like plasma or it may be the result of a reaction like from a fermentation broth, bio reactor, digestion, or other type of sample preparation.

The fluid is preferably a liquid but may also be or comprise a gas and/or a supercritical fluid (as e.g. used in supercritical fluid chromatography—SFC—as disclosed e.g. in U.S. Pat. No. 4,982,597 A).

The pressure in the mobile phase might range from 2-200 MPa (20 to 2000 bar), in particular 10-150 MPa (100 to 1500 bar), and more particularly 50-130 MPa (500 to 1300 bar).

The HPLC system might further comprise a detector for detecting separated compounds of the sample fluid, a fractionating unit for outputting separated compounds of the sample fluid, or any combination thereof. Further details of HPLC system are disclosed with respect to the aforementioned Agilent HPLC series, provided by the applicant Agilent Technologies.

### BRIEF DESCRIPTION OF DRAWINGS

Other objects and many of the attendant advantages of embodiments of the present disclosure will be readily appreciated and become better understood by reference to the following more detailed description of embodiments in connection with the accompanying drawings. Features that are substantially or functionally equal or similar will be referred to by the same reference signs.

FIG. 1 illustrates an analytical device with a sample injector, according to an exemplary embodiment.

FIG. 2 illustrates a sample injector, according to an exemplary embodiment.

FIG. 3 illustrates a sample injector, according to a further exemplary embodiment.

FIG. 4A illustrates a sample injector, according to an exemplary embodiment.

FIG. 4B illustrates the sample injector of FIG. 4A in a different position.

FIG. 4C illustrates the sample injector of FIG. 4A in a different position.

FIG. 5A illustrates a sample injector movable in the Z-direction, according to an exemplary embodiment.

FIG. 5B illustrates a movement associated with the sample injector of FIG. 5A.

FIG. 6A illustrates a sample injector with an alignment element, according to an exemplary embodiment.

FIG. 6B illustrates the sample injector of FIG. 6A in a different position.

FIG. 6C illustrates the sample injector of FIG. 6A in a different position.

### DETAILED DESCRIPTION

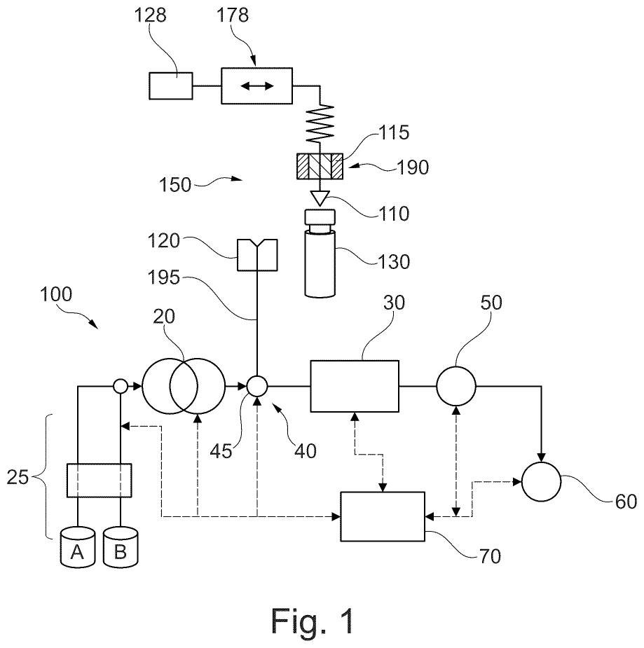

Referring now in greater detail to the drawings, FIG. 1 depicts a general schematic of an analytical device 100 (for example, configured as a sample separation device). A solvent (mobile phase) drive 20 (such as a pump) receives a solvent as the mobile phase from a solvent supply 25. The solvent drive 20 drives the mobile phase through a separating device 30 (such as a chromatographic column), which can be seen here as the analytical domain of the device. A sample injector 40 (also referred to as sample introduction apparatus, sample dispatcher, etc.) is provided between the solvent drive 20 and the separating device 30 in order to subject or add (often referred to as sample introduction) portions of one or more sample fluids into the flow of a mobile phase at a mixing point 45. The separating device 30 is adapted for separating compounds of the sample fluid, e.g. a liquid. A detector 50 is provided for detecting separated compounds of the sample fluid. A fractionating unit 60 can be provided for outputting separated compounds of sample fluid. In one embodiment, at least parts of the sample injector 40 and the fractionating unit 60 can be combined, e.g. in the sense that some common hardware is used as applied by both of the sample injector 40 and the fractionating unit 60.

The separating device 30 may comprise a stationary phase configured for separating compounds of the sample fluid. Alternatively, the separating device 30 may be based on a different separation principle (e.g. field flow fractionation).

While the mobile phase can comprise one solvent only, it may also be mixed of plurality of solvents (solvent supply 25). Such mixing might be a low pressure mixing and provided upstream of the solvent drive 20, so that the solvent drive 20 already receives and pumps the mixed solvents as the mobile phase. Alternatively, the solvent drive 20 might comprise plural individual pumping units, with plural of the pumping units each receiving and pumping a different solvent or mixture, so that the mixing of the mobile phase (as received by the separating device 30) occurs at high pressure and downstream of the mobile phase drive 20 (or as part thereof). The composition (mixture) of the mobile phase may be kept constant over time, the so-called isocratic mode, or varied over time, the so-called gradient mode.

A data processing device 70, which can be a conventional PC or workstation, might be coupled (as indicated by the dotted arrows) to one or more of the devices in the analytical device 100 in order to receive information and/or control operation.

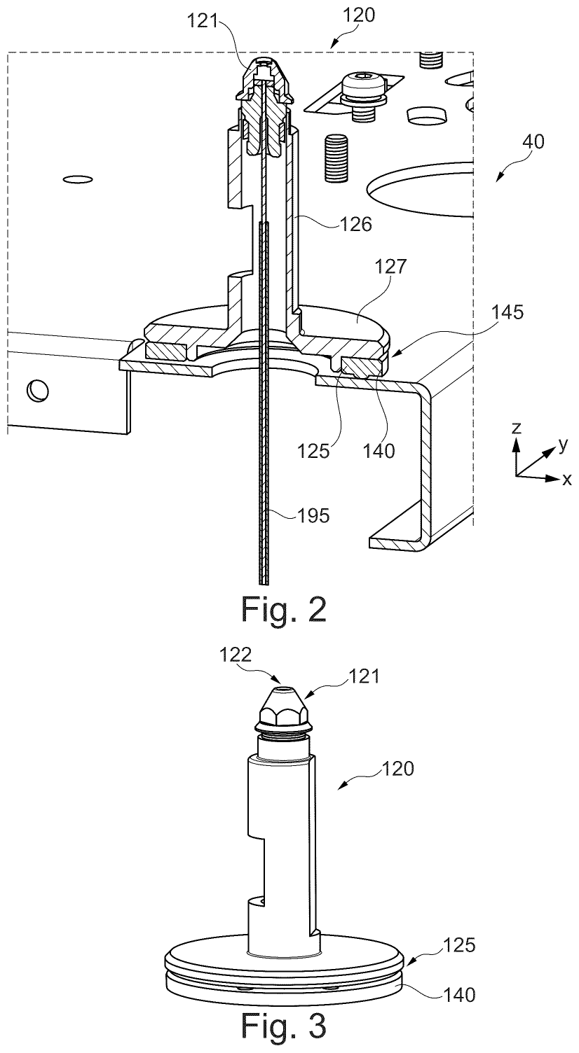

FIG. 2 illustrates a sample injector 40 according to an exemplary embodiment. The sample injector 40 comprises a needle seat mounting device 140, here configured as a mounting/support plate. On top of the mounting plate 140, there is mounted the needle seat 120 (shown in cross-section). In this example, the needle seat 120 comprises an elongated part 126 that is oriented along the vertical direction (Z-axis) towards an approaching needle 110 (FIG. 1). The elongated part 126 is connected at the bottom to a planar part 127 that is oriented along the horizontal/planar direction (along the X-Y plane). The planar part 127 is hereby arranged on the mounting plate 140. At the top, the elongated part 126 comprises an opening 122 to receive the approaching needle 110. The opening 122 is further connected to an internal channel of the needle seat 120, wherein said internal channel is directly connected to an injection path 195 that leads to the analytical domain (e.g. a separation column) of the analytical device 100. In this manner, the approaching needle 110 can be moved into the opening 122 and inject the sample into the injection path 195 via a fluidic coupling (eventually under high pressure). To fulfill this task in an efficient and reliable manner, there needs to be an alignment between the orientation of the needle seat 120 and the orientation of the approaching needle 110; in other words: a misalignment has to be avoided.

In order to solve this problem, the needle seat 120 is mounted on the needle seat mounting device 140 in a floating manner. Thereby, the needle seat 120 is movable, in this example in the planar direction (along the X-Y plane), and can be automatically aligned by the approaching needle 110 (which can be stationary, i.e. non-floating). In the example shown, the floating mount is realized by a floating region 125 directly between the planar part 127 of the needle seat 120 and the main surface of the needle seat mounting device 140. Said floating region 125 can be e.g. a surface with a lubricant or a ball bearing.

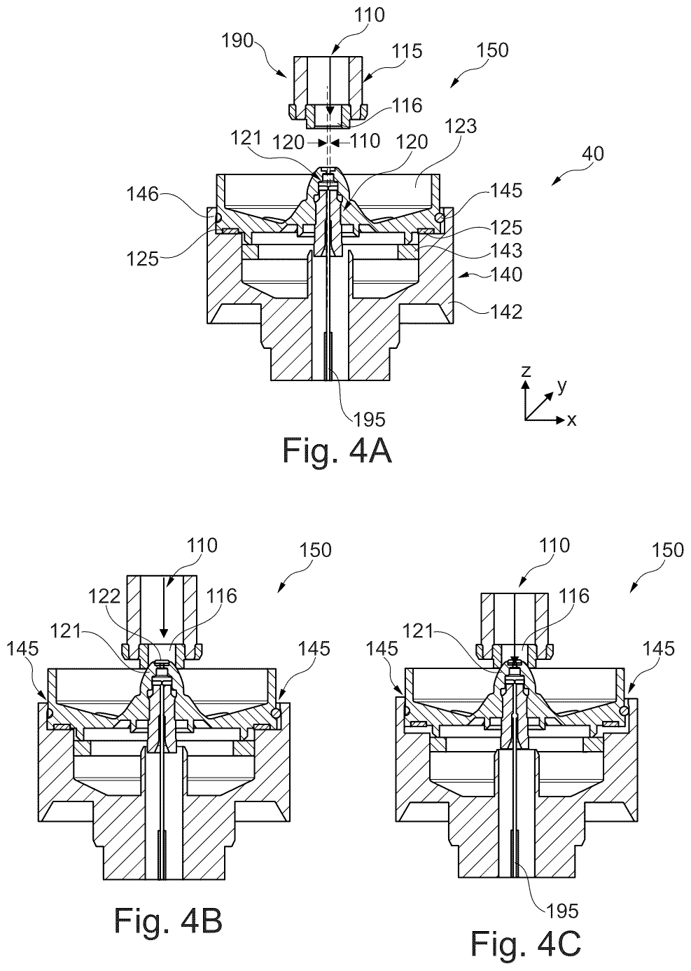

FIG. 3 illustrates a needle seat 120 according to an exemplary embodiment. Said needle seat 120 is very similar to the one described for FIG. 2, also comprising an elongated part 126 and a planar part 127, but shown in a closed illustration. In said closed view, it can be seen that the top of the needle seat 120, where the opening 122 is located, comprises a tapering part 121 that tapers from the elongated part 126 towards the opening 122 along the vertical direction. As will be explained below, the tapering part 121 enables an efficient automatic alignment with an opening 116 of an approaching guidance (pusher) device 115 (FIG. 4A) of a transport device that is coupled to the needle 110.

FIGS. 4A to 4C respectively illustrate a sample injector arrangement 150 with a sample injector 40 and a sample transport device 190 according to an exemplary embodiment. The sample transport device 190 is only partially shown by a guidance (e.g. pusher or gripper) device 115 that surrounds the needle 110 and comprises an opening 116, through which the needle 110 can be moved/guided (along the vertical direction) in order to uptake/aspire a fluidic sample and to inject said sample into the sample injector 40 (needle seat 120). As shown in FIG. 1, the sample transport device 190 may include a moving arm 178 coupled to the needle 110 and configured to move the needle 110 from a sample up-take position towards the needle seat 120. The moving 178 may be driven or actuated by an appropriate driving device 128 as appreciated by persons skilled in the art.

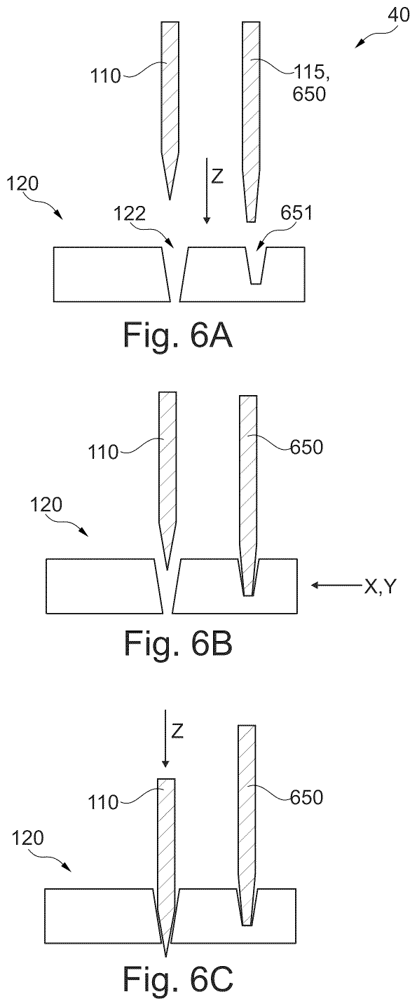

FIG. 4A: the sample injector 40 comprises a needle seat 120 with an elongated part 126 and a planar part 127 as described for FIGS. 2 and 3 above. Yet, the needle seat 120 of the example of FIG. 4 is a more complex structure. The planar part 127 extends along the horizontal plane and comprises a sidewall 123 that circumferentially encloses the elongated part 126 (see also FIG. 6).

The needle seat mounting device 140 comprises a massive tower structure 142 with a support plate 143 for accommodating the needle seat 120. A channel extends from the top opening 122 of the needle seat 120 through the elongated part 126 and the tower structure 142 of the needle seat mounting device 140 to the injection path 195. It can be seen that there is no form-fit connection between the sidewall 123 and the planar part 127 of the needle seat 120 and a sidewall 146 of the tower structure 142 of the needle seat mounting device 140. Instead, there is a tolerance region 145 (a free space) between the needle seat sidewall 123 and the needle seat mounting device sidewall 146 along the device circumferential direction (around the Z-axis). Further, a floating region 125 (here a floating surface as described above) is arranged directly between the needle seat 120 and the needle seat mounting device 140 close to the tolerance region 145 in the circumferential direction.

Thus, the needle seat 120 can move in the horizontal plane due to the tolerances 145 and the floating region 125. In other words, the needle seat 120 is mounted in the sample injector 40 in a floating manner. It can be seen that an orientation (here shown along the Z-axis) of the needle 110 and an orientation (also shown along the Z-axis) of the needle seat 120 are misaligned with respect to each other. Nevertheless, the orientation of the floating needle seat 120 can be automatically aligned to the orientation of the needle 110, when the needle 110 is approaching the needle seat 120.

FIG. 4B: this example is based on the embodiment of FIG. 4A. The sample transport device 190 has been lowered (moved downwards) and the bottom of the guidance device 115 (to which the needle 110 is coupled) approaches the needle seat 120. It can be seen that the tapering part 121 of the needle seat 120 (where the opening 122 for the needle 110 is located) has a smaller diameter than the opening 116 (through which the needle 110 is guided) of the guidance device 115. Indeed, the tapering part 121 fits well into the opening 116, while the sample transport device 190 is lowered along the direction of gravity. Thus, the tapering part 121 will find its position within the opening 122 automatically, thereby aligning the orientations (along Z) of the needle 110 and the floating needle seat 120 as well.

FIG. 4C: in a further step (based on FIG. 4B), the orientation of the needle seat 120 is aligned with the orientation of the needle 110, and the tapering part 121 fits perfectly (eventually via a form-fit connection) into the opening 116 of the guidance device 115. Now, the needle 110 itself is lowered, passes perfectly through the opening 122 of the needle seat 120, and injects the fluidic sample into the injection path 195. In comparison to FIGS. 4A and 4B, it can be seen that the needle seat 120 has been moved in the horizontal plane (to the right side) in the tolerance region 145, i.e. has been aligned to the approaching needle 110.

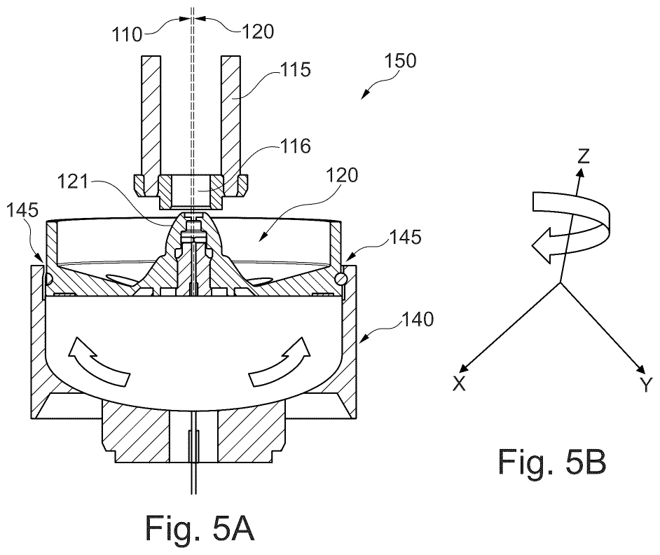

FIGS. 5A and 5B illustrate a sample injector 40 with a needle seat 120 being floatable in the Z-direction, according to an exemplary embodiment. This embodiment is very similar to the ones described for FIGS. 4A to 4C. Again, the misalignment of the orientations of needle seat 120 and needle 110 are illustrated. Yet, in this example, the needle seat 120 is not only mounted in a floatable manner with respect to the horizontal direction (the plane), but is further mounted in a floating manner in the vertical direction (along Z); in other words: a rotation around the Z-axis. This possible movement is illustrated by the arrows in FIG. 5A. FIG. 5B shows schematically a movement (due to a mounting in a floating manner) around the Z-axis. Thus, a needle seat 120 with degrees of freedom in the X-Y plane may be supplemented by a tilt around the Z-axis.

FIGS. 6A to 6C illustrate a further embodiment, wherein an alignment element 650 (here an alignment pin) is used as the guidance device 115 to align the approaching needle 110 to the floating needle seat 120. In this example, the guidance device 115 is configured as said alignment element 650 instead of a pusher device. The alignment element 650 is coupled coaxially with the needle 110 (preferably fixed in the moving direction) to provide the orientation/alignment of the needle 110 to the needle seat 120. In this example, the axis of movement (Z) of the needle 110 as well as the axis of movement of the alignment element 650 are in parallel with each other. The orientation provided by the alignment element 650 thus automatically leads to the desired orientation of the needle 110.

FIG. 6A: the needle 110 and the alignment element 650 move coaxially in the vertical direction (Z) towards the needle seat 120. The needle 110 is located closer to the injection opening 122 of the needle seat 120, while the alignment element 650 (which protrudes in comparison to the needle 110) is located closer to an alignment opening 651 of the needle seat 120. The distance between needle 110 and alignment element 650 is hereby fixed, and the distance between injection opening 122 and alignment opening is also fixed.

FIG. 6B: the alignment element 650 moves into the alignment opening 651 and thereby automatically aligns the floating needle seat 120 in the horizontal plane (X, Y) to the alignment element 650. Since the distance between needle 110 and alignment element 650 is fixed, the needle 110 is automatically in the correct orientation with respect to the injection opening 122 (having a fixed distance to the alignment opening 651).

FIG. 6C: while the alignment element 650 remains in the alignment opening 651, the aligned needle 110 can be moved further into the injection opening 122 to inject a fluid.

It should be noted that the term “comprising” does not exclude other elements or features and the term “a” or “an” does not exclude a plurality. Also elements described in association with different embodiments may be combined. It should also be noted that reference signs in the claims shall not be construed as limiting the scope of the claims.

### REFERENCE SIGNS

20 Solvent drive
25 Solvent supply
30 Separating device
40 Sample injector
45 Mixing point
50 Detector
60 Fractionating unit
70 Data processing device
100 Analytical device, sample separation device
110 Needle
115 Guidance device
116 Opening guidance device
120 Needle seat
121 Tapering part
122 Injection opening
123 Needle seat sidewall
125 Floating region
126 Elongated part
127 Planar part
128 Drive
130 Sample container, vial
140 Needle seat mounting device
142 Tower
143 Support plate
145 Tolerance region
146 Needle seat mounting device sidewall
150 Alignment element, alignment pin
151 Alignment opening
178 Moving arm
190 Sample transport device
195 Sample injection path

1. A sample injector for an analytical device, the sample injector comprising:
a needle;
a guidance device coupled with the needle; and
a needle seat configured to receive the needle for a sample injection into an injector path, wherein:
the needle seat is mounted in a floating manner, and
the guidance device is configured to align an orientation of the needle seat with respect to an orientation of the needle.

2. The sample injector according to claim 1, further comprising one of:
a needle seat mounting device configured to mount the needle seat in the floating manner;
a needle seat mounting device configured to mount the needle seat in the floating manner, wherein the needle seat mounting device is a stationary device.

3. The sample injector according to claim 2, wherein the needle seat mounting device comprises a tolerance region configured to allow a movement of the needle seat.

4. The sample injector according to claim 1, further comprising a floating region onto which the needle seat is mounted.

5. The sample injector according to claim 4, comprising a needle seat mounting device configured to mount the needle seat in the floating manner, wherein the floating region is arranged between the needle seat mounting device and the needle seat.

6. The sample injector according to claim 4, wherein the floating region comprises at least one of the following: a ball bearing; a roller bearing; a fluid bearing; an oil bearing; an air bearing; a gel bearing; a friction-reducing material; a sliding surface; a lubricant.

7. The sample injector according to claim 1, configured so that the needle seat is floating in a planar direction and/or at least partially floating in a vertical direction.

8. The sample injector according to claim 1, further comprising one of:
the injector path, coupled with the needle seat, and configured to receive the injected sample from the needle;
the injector path, coupled with the needle seat, and configured to receive the injected sample from the needle, wherein the injector path is mounted in a stationary manner.

9. The sample injector according to claim 1, wherein the needle seat comprises a tapering part, and the sample injector further comprises at least one of the following features:
wherein the tapering part comprises a cone-like part;
wherein the guidance device interacts with the tapering part to align the orientation of the needle seat with respect to the orientation of the needle;
wherein the tapering part is configured to be automatically aligned by an approaching opening of the guidance device;
wherein the tapering part is tapered in a direction toward the approaching needle or in a direction opposite to the approaching needle.

10. The sample injector according to claim 1, comprising at least one of:
wherein the guidance device and the needle are fixedly coupled with each other with respect to their axis of movement;
wherein an axis of movement of the guidance device is fixedly coupled with an axis of movement of the needle;
wherein an axis of movement of the guidance device is fixedly coupled with an axis of movement of the needle in parallel or coaxially.

11. A sample injector arrangement, comprising:
the sample injector according to claim 1; and
a sample transport device comprising the needle for injecting the sample into the needle seat,
wherein the needle is arranged in a non-floating manner or in a floating manner.

12. The sample injector arrangement according to claim 11, wherein the sample transport device further comprises a moving arm, coupled to the needle, and configured to move the needle from a sample up-take position towards the needle seat.

13. The sample injector arrangement according to claim 12, configured so that the orientation of the needle seat is aligned automatically with respect to the orientation of the needle at least along an axis in which the needle and/or the moving arm is stationary.

14. The sample injector arrangement according to claim 12, wherein the guidance device is coupled to the moving arm.

15. The sample injector according to claim 1, comprising at least one of:
wherein the guidance device comprises an opening configured to automatically align the orientation of the needle seat;
wherein the guidance device comprises an opening configured to automatically align the orientation of a tapering structure of the needle seat.

16. An analytical device, comprising:
the sample injector according to claim 1; and
an analytic domain coupled to the sample injector and configured to analyze the injected sample.

17. The analytical device according to claim 16, wherein the analytic domain comprises at least one of: a sample separation device; a high-performance liquid chromatography device.

18. A method, comprising:
mounting a needle seat of an analytical device in a floating manner;
approaching a needle being coupled to a guidance device to the needle seat; and
aligning with the guidance device an orientation of the needle seat with respect to an orientation of the needle.

19. The method according to claim 18, further comprising:
injecting the sample from the needle into the needle seat and into an injector path of the analytical device.

20. A method of using a needle seat for an analytical device in a floating manner, so that an axis misalignment between the orientation of the needle seat and an orientation of an approaching needle is automatically compensated for.
